(19) United States
(12) Patent Application Publication
(10) Pub. No.: US 2012/0331176 A1
(43) Pub. Date: Dec. 27, 2012

(54) METHOD FOR TRANSPORT AND RECOVERY OF CLIENT CLOCKING ACROSS ASYNCHRONOUS SERVER NETWORKS

(75) Inventors: MARK WIGHT, Ottawa (CA); MOHAMAD SAMI MOHAMAD, Nepean (CA); ERIK TROUNCE, Nepean (CA)

(73) Assignee: EXAR CORPORATION, Fremont, CA (US)

(21) Appl. No.: 13/167,895

(22) Filed: Jun. 24, 2011

(51) Int. Cl. G06F 15/16

(52) U.S. Cl. 709/248

(57) ABSTRACT

At a generator, frame events are received indicative of frame boundaries. The amount of client data received between frame events is counted to get a raw count. The raw count is low-pass filtered to get a smoothed value. At a receiver, an indication of the smoothed count is received from the generator; and the indication is smoothed using a low-pass filter and used to produce a client data rate.

### FIELD OF THE INVENTION

The present invention relates to the recovery of a client clock from data packed within frames of another protocol.

### BACKGROUND

In order for a constant bit rate data protocol to be carried successfully across a network, a method for matching the bit rate of the receiver with the bit rate of the sender must be employed. Without such a method, rate mis-matches between the sender and receiver will result in dropped or corrupted traffic due to buffer under-runs or over-runs. In a synchronous network, the sender and receiver, as well as any intermediate network elements, employ complex methods for ensuring their local clocks are synchronized to a master clock. In an asynchronous network, network elements operate on independent local clocks, avoiding the complex synchronization of clocks, but requiring other methods for matching data rates. Different mapping protocols have independently evolved different methods for dealing with this problem in asynchronous networks, usually involving idle/filler data inserted at the sender which is then added to or removed at the receiver.

In an asynchronous network, it is desirable for the receiver to adapt its local clock to match the sender's clock, given only the information included in the received data stream.

Present standards define methods of communicating a client's rate with respect to a mapping protocol's rate, for example by encoding the amount of client data into the mapping protocol's overhead. In some prior systems, the decision on the amount of client data to send is made using a First-In-First-Out (FIFO) buffer. The sender can decide to send more data when the FIFO fill level is over a threshold, or to send less data when the FIFO fill level is below a different threshold. This however results in an undesirably variable recovered clock since there can be certain time periods where control data is sent, thus the FIFO will tend to fill unevenly.

### SUMMARY

A method of the present invention concerns a method for the calculation and recovery of a data rate across a network. The data rate can be communicated across a network and extracted at the receiver, regardless of the mapping protocols used, or the number of layers of mapping protocols. Furthermore, this method minimizes the jitter caused by the required quantization of the data rate, such that the far end may recover the sender's clock rate using standard off-the-shelf phase-locked-loop (PPL) devices.

Generators can produce smoothed indications of the client clock. These smoothed indications can be provided based on a raw count of client data between frame events. The frame events being the start of one frame and the end of that or a later frame. The raw count is put through a low-pass filter to produce a smoothed indication. The smoothed indication can be then sent along with the data to a receiver. The smoothed indication (also called a timestamp) can be processed to produce a differential value, or a non-differential value can be used.

At the receiver, the timestamp is low pass filtered and used to recover a client clock value. The filtered timestamp can be divided by the frame event period to get the client clock value.

The use of the transmitted timestamp values allow for the client clock to be better recovered at the receiver.

Any number of generators and receivers can be chained together.

### BRIEF DISCUSSION OF THE DRAWINGS

FIG. 1 is a diagram illustrating a generator and receiver of one embodiment of the present invention.

FIG. 2 is a diagram illustrating the operation of generators and receivers of one embodiment in the present invention.

FIGS. 3-4 illustrate multi-level mapping examples using multiple generators and receivers to implement different protocols.

FIG. 5 illustrates an exemplary generator of one embodiment.

FIG. 6 illustrates an exemplary receiver of one embodiment.

### DETAILED DESCRIPTION

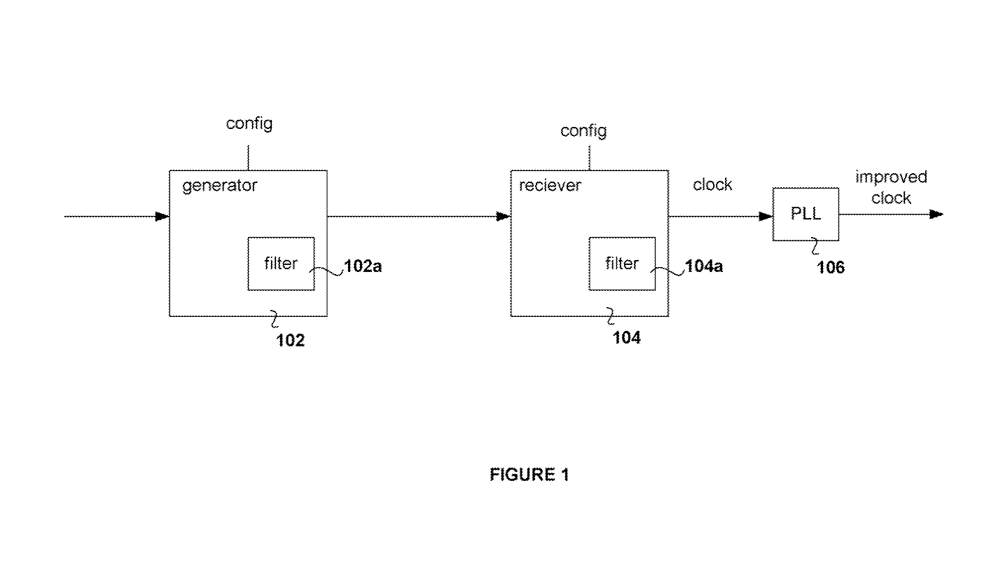

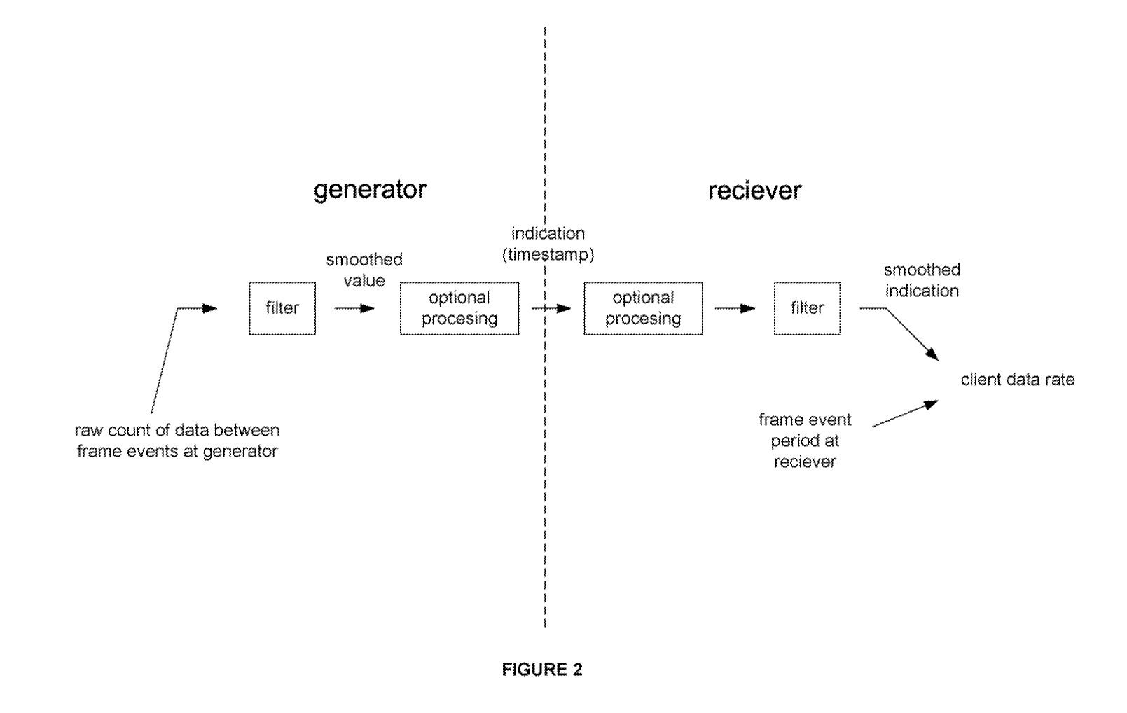

FIG. 1 shows a generator 102 and receiver 104. At the generator 102, frame events indicative frame boundaries are determined. The frame events can be the start of one frame and the end of that or a later frame. The amount of client data received between frame events is counted to get a raw count. Low pass filter 102a is used to filter the raw count to get a smoothed value. The smoothed value is used to produce a timestamp value.

In a Generic Framing Procedure (GFP) mode, client management frames are used to send the smoothed value as the indication. In an Asynchronous Mapping Procedure (AMP) mode, the indication sent is a differential count produced from the smoothed value. In a Generic Mapping Procedure (GMP) mode, the timestamp is encoded into the mapping procedure's overhead. Other mapping procedures can also be used.

The receiver 104 receives the indication of the smoothed count (such as the timestamp). The indication is smoothed using a low-pass filter 104a and smoothed indication is used (along with a frame event period) to produce a client data rate. In the AMP mode, the indication is a differential count and a non-differential value can be produced before the filtering.

The smoothed indication can be divided by a frame event period to get the client data rate. The receiver can then produce a clock from the client data rate. This clock can be sent to a phase lock loop (PLL) to produce an improved clock.

The receivers and generators can be configurable for multiple protocols. For example, the receivers and generators can be used to facilitate an Ethernet client signal mapped into an Optical Transport Network (OTN) OPU0 mapping protocol, and the same receivers and generators could instead be configured for an ODU0 client signal mapped into an OPU2 mapping protocol. In one embodiment, the generator is adapted to map an ODUx signal into an OPUy signal where y is greater than x.

A receiver can send outputs to multiple additional receivers configured for another protocol. A generator can send outputs to multiple additional generators (for mapping the same client signal into other mapping signals, which could be the same protocol or a different protocol).

The receiver and generator can also define failure mode behavior. If a client signal fails (i.e. you are no longer getting a valid signal or rate), it is desirable that at the far end a valid fail-mode client signal is generated at a valid client rate. For example, if you are mapping a 100 Mbps Ethernet signal into an OTU1 and someone pulls the Ethernet cable, you want to continue transmit an OTU1 signal with 100 Mbps client data even though your client data rate has effectively dropped to 0 (the actual client data sent can be a failure mode signal defined by the standards). Generator blocks can be provisioned to hold the last known good rate of the client signal and provide a timestamp based on this held-over rate until the client signal recovers. Similarly, receiver blocks will continue to generate the same clock/frame event rates when they stop receiving new timestamps or frame events, to deal with failures at either the received client signal or mapping signal. Furthermore, both Generator and receiver blocks have provisionable valid ranges of timestamps, so if the client signal rate falls outside of the valid range, the generated timestamps or clocks will remain in the valid range.

A client data signal is mapped into a server protocol, where the client and server clock rates are independent. A generator is an element which quantifies the client data rates based on the server's clock rate, and a receiver is an element which recovers a client clock based on the information received from a server at the server's clock rate. In a system where a number of client signals are being mapped/de-mapped into one or more layers of server protocols, a pool of generators and receivers are used to be connected between client and server layers. Each generator and monitor does not need to know the type of client or server protocol, and the client and server circuits' clock frequencies do not have to be related in any way. A single chip can contain the pool of multiple generators and receivers that can be used as needed.

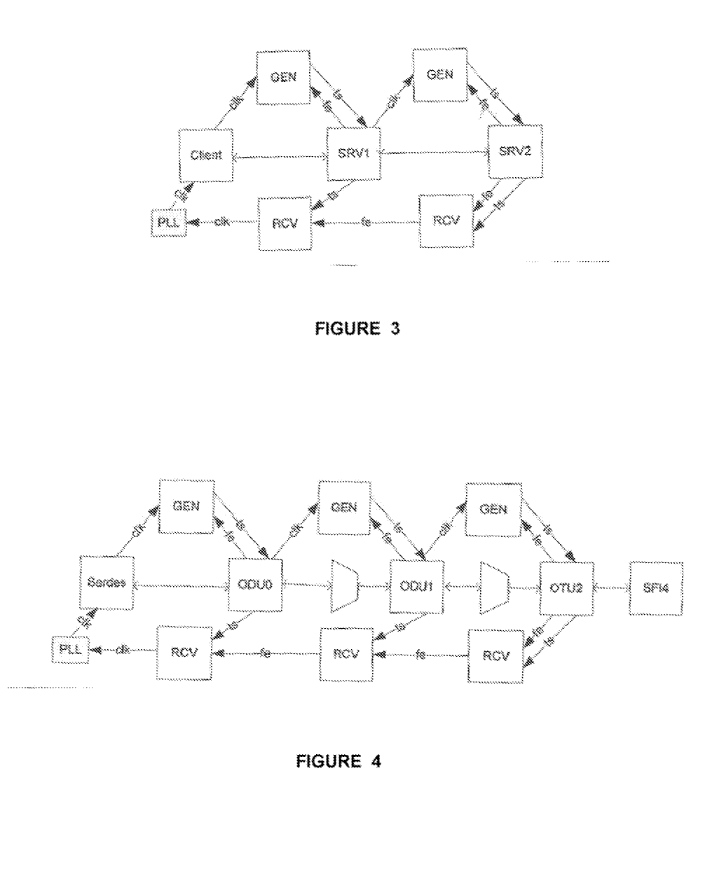

A generator receives a clock from a client signal and a frame event (FE) from a server signal. Each edge of the client clock indicates some fixed amount of data has been received for the client signal. The server frame event indicates a frame boundary of the server protocol has been reached. The generator counts the amount of client data received between a fixed number of server frame events. The raw count is passed through a low-pass filter to remove quantization errors and client jitter and the smoothed result is sent to the server circuit. This value, termed a timestamp (TS), represents the client data rate, relative to the server data rate. Depending on the server protocol, this value is either encoded directly into the protocol's overhead (e.g. Optical Transport Network (OTN) Generic Mapping Procedure (GMP)), sent as a management packet (e.g. Generic Frame Protocol (GFP)), or used to control positive/negative justification (e.g. OTN Asynchronous Mapping Procedure (AMP)). Other means of communicating the timestamp may also be employed. If multiple layers of signal mapping are required, then the server protocol being mapped into the next layer becomes the client signal for another generator circuit. Any generator can be assigned to any client/server combination, and the counts generated are interpreted in a protocol-dependent way by each server circuit. Each server layer mapping requires calculating and communicating its client data rate relative to the server rate. FIG. 3 shows a generic 2-level mapping application, FIG. 4 shows an OTN application involving three layers of server mapping.

The client clock received by a generator indicates a fixed amount of client data has been received. This fixed amount of data may be any amount, from a single bit to 10 s of bits. The server timestamp can represent a fixed number of 8-bit bytes, where the fixed number of bytes may be 1 or more, mapped into the server protocol. The client signal may also be processed before being mapped into the server protocol (e.g. Fiber Connection (FICON) 8b/10b transcoding converts 10-bit 8b/10b encoded codewords into 9-bit transcoded values), so while the client clock represents the data before processing, the server timestamp must represent the data rate post-processing. As a result, the generators have the ability to perform a range of multiplication and/or division of the received client data rate before the generation of the server timestamps.

The generator also can ensure that any timestamps created fall within a valid range for the particular client to server mapping. In the case of a client signal failure, the generator continues to generate valid timestamps for the server, despite not receiving a client data clock rate that may be out of the normal range.

A receiver performs the inverse operation of the generator on a received signal. At the far end, a client signal mapped inside a server signal is received, along with the encoding of the client data rate relative to server data rate. A timestamp is decoded; either directly by extracting it from the server protocol's overhead, extracted from a management frame, or synthesized from positive/negative stuff events. The server circuit provides a receiver circuit its server frame event and a timestamp. The timestamps are smoothed using a low-pass filter to remove jitter and then used to synthesize a client data rate by dividing the timestamp by the server frame event period. If there are additional mapping layers to be allocated, a frame event is received from the first receiver and the decoded timestamp is received from the first client; this becomes the server for the next layer. Then final receiver synthesizes a clock from the smoothed client data rate, which is passed to a Phase Lock Loop (PLL) for final jitter attenuation.

As with the generator case, the receiver must incorporate a range of multiplication/division of the client timestamps before generating the client clock or frame events, to accommodate different data amounts indicated by the timestamps, the client clocks, and any client processing required in the client mappings.

The communication of the timestamps across the network depends on the server protocol. Some protocol mappings such as OTN GMP include timestamps directly in their protocol definition and are used directly. For an OTN AMP mapping, the timestamps provided fall in a range matching the justification possibilities of the mapping. For example, if 1 positive and 1 negative justification opportunity exists, the timestamps generated will be a nominal value, +/−1. In the case of a GFP mapping, no standard exists for communication of a client rate, therefore this invention uses GFP client management frames to communicate timestamps. GFP has no concept of a regular periodic frame event, however it is assumed that it is always mapped into a protocol that does. It is also assumed that the protocol GFP signal is being mapped does not employ any data rate adjustment techniques (since it would be redundant as it is provided by GFP). Therefore, the mapping protocol GFP is being mapped to provide the frame event which triggers the generation of a timestamp which is sent via the GFP management frame.

In the standard implementation, rate justification is controlled by FIFO levels in the data path. This invention addresses the following issues, not covered by prior art:

1. Protocol-independent: Can be used for any client into server mapping.

2. Extensible: Can handle any number of mapping layers

3. Better jitter performance: Smoothing of timestamp generation and reception results less jitter.

4. Recovery of clocking in a GFP mapping configuration.

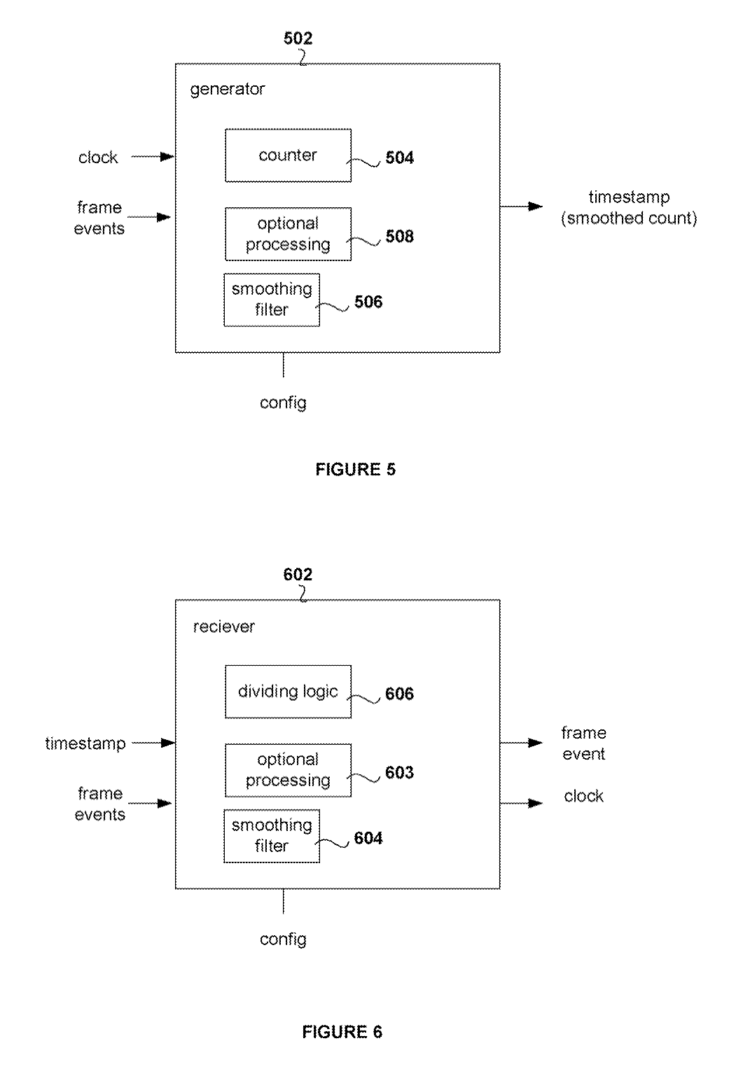

FIG. 5 shows an exemplary generator 502. A clock received on line 510 can have jitter with edges corresponding to data that is to be sent between frame events. Counter 504 can count the number of clock pulse corresponding to data to be sent between frame events. Smoothing filter 506 can smooth the raw count value. Optional processing 508 can be used to make the timestamp value a differential count. The generator 502 can be configured to use differential or non-differential counts.

FIG. 6 shows an exemplary receiver 602. The receiver 602 receives the timestamp and frame events. Optional processing 603 can be used when the timestamp is a differential value. The timestamp value is smoothed with smoothing filter 604 and then the smoothed value and the frame event are used in dividing logic 606 to produce a clock value. The receiver can also produce a frame event.

A client can also be mapped into SONET/SDH. In that case, a client is mapped into GFP, then into SONET/SDH. The generator side is the same as any other GFP mapping, i.e. GFP carries the timestamp and the frame event comes from SONET/SDH. The receiver side can be different however since SONET/SDH has its own clock justification (similar to OTN AMP) on top of the client mapping justification. In one embodiment, this is not needed in the transmit side because we never generate justification events in the transmit direction. In this embodiment, justification events only occur during transport in the network. SONET/SDH does not contain any timestamps per se, so a timestamp can be synthesized by the SONET/SDH receive process by counting the number of payload bytes between SONET/SDH frame events. This count along with the frame event is sent to the receiver which creates a frame event representing the rate of the SONET/SDH payload. The synthesized frame event is sent to another receiver which also receives the GFP timestamp to create the client data rate.

A non-integer data rate can also be sent. OTN's GMP can be sent to calculate and send an indication of the non-integral portion of the timestamp. For example, say the client data rate with regards to the server protocol's data rate ends up such that there is 100.5 bytes of data going into each server frame. Since most protocols operate on an integer number of bytes, what we would end up sending is 100 bytes one frame and 101 the next, alternating back and forth. The timestamp can reflect this. GMP defines a fractional count, which represents a fractional count of client data received but not sent in the server frame. In this example, the fractional count would be 0.5 in the frame where we have sent 100 bytes and 0.0 in the frame that we have sent 101 bytes (the 0.5 represents the half a byte received at that point in time but not included in the server frame). The generators can have the ability to calculate this fractional value and provide it to the server protocol mappers, and it is used by the GMP mappers and included in the GFP mappers, but it's ignored by the AMP mappers since there is no standard overhead byte to send it. This value can be used to better smooth the output client clock.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A method of recovering a client clock comprising:
at a generator, receiving frame events indicative of frame boundaries;
at the generator, counting the amount of client data received between frame events to get a raw count,
at the generator, low pass filtering the raw count to get a smoothed value;
at a receiver, receiving an indication of the smoothed value; and
at the receiver, smoothing the indication using a low-pass filter and using the smoothed indication to produce a client data rate.

2. The method of claim 1, wherein the smoothed indication is divided by a frame event period to get client data rate.

3. The method of claim 2, wherein the receiver produces a clock from the client data rate.

4. The method of claim 3, wherein the clock is sent to a phase lock loop (PLL) to produce an improved clock.

5. The method of claim 1, wherein the receivers and generators are configurable for multiple protocols.

6. The method of claim 1, wherein the receivers and generators are configurable for optical protocols.

7. The method of claim 1, wherein the generator is adapted to map an ODUx signal into an OPUy signal where y is greater than x.

8. The method of claim 1, wherein the indication is a non-integer value.

9. The method of claim 1, wherein multiple configurable receivers and generators are on a single chip.

10. The method of claim 1, wherein in a Generic Framing Procedure (GFP) mode, client management frames are used to send the smoothed value as the indication.

11. The method of claim 1, wherein in an asynchronous mapping procedure (AMP) mode, the indication is a differential count produced from the smoothed count.

12. The method of claim 1, wherein a receiver sends outputs to multiple additional receivers configured for another protocol.

13. The method of claim 1, wherein the generator sends outputs to multiple additional generators.

14. The method of claim 1, wherein the indications and the smoothed values are timestamps and wherein the receiver and generator stores valid ranges of timestamps and keep any generated timestamp and/or clock within the valid ranges.

15. The method of claim 1, wherein the generator stores a last known good rate value and upon a client signal fail, continues to send a signal at the last known good rate.

16. The method of claim 1, wherein the receiver continues to generate clocks and/or frame event rates upon a signal failure.

17. An apparatus comprising:
multiple generators adapted to receive frame events and to count an amount of client data received between frame events to get a raw count, the multiple configurable generators adapted to low-pass filter the raw count to produce a smoothed value and to use the smoothed value to produce an indication of the smoothed value; and
multiple receivers adapted to smooth the indication using a low-pass filter and use the smoothed indication to produce a client data rate.

18. The apparatus of claim 17, wherein the smoothed indication is divided by a frame event period to get client data rate.

19. The apparatus of claim 18, wherein the receiver produces a clock from the client data rate.

20. The apparatus of claim 19, wherein the clock is sent to a phase lock loop (PLL) to produce an improved clock.

21. The apparatus of claim 17, wherein the receivers and generators are configurable.

22. The apparatus of claim 17, wherein the receivers and generators are configurable for optical protocols.

23. The apparatus of claim 17, wherein the generator is adapted to map an ODUx signal into an OPUy signal where y is greater than x.

24. The apparatus of claim 17, wherein the indication is a non-integer value.

25. The apparatus of claim 17, wherein in a Generic Framing Procedure (GFP) mode, client management frames are used to send the smoothed value as the indication.

26. The apparatus of claim 17, wherein in an asynchronous mapping procedure (AMP) mode, the indication is a differential count.

27. The apparatus of claim 17, wherein a receiver sends outputs to multiple additional receivers configured for another protocol.

28. The apparatus of claim 17, wherein the generator sends outputs to multiple additional generators.

29. The apparatus of claim 17, wherein the indications and the smoothed values are timestamps and wherein the receiver and generator stores valid ranges of timestamps and keep any generated timestamp and/or clock within the valid ranges.

30. The apparatus of claim 17, wherein the generator stores a last known good rate value and upon a client signal fail, continues to send a signal at the last known good rate.

31. The apparatus of claim 17, wherein the receiver continues to generate clocks and/or frame event rates upon a signal failure.
